(19) United States
(12) Patent Application Publication
(10) Pub. No.: US 2007/0237879 A1
(43) Pub. Date: Oct. 11, 2007

(54) NOT-READY-TO-EAT RECONSTITUTED GRAIN PRODUCT AND MANUFACTURE METHOD THEREOF

(75) Inventors: Jiing-Yang Wu, Hsinchu (TW); Lin-Shynag Tzeng, Hsinchu (TW); I-Chin Wang, Hsinchu (TW); Chin-Hung Chang, Hsinchu (TW); Bao-Hung Huang, Hsinchu (TW)

Correspondence Address: OCCHIUTI ROHLICEK & TSAO, LLP, 10 FAWCETT STREET, CAMBRIDGE, MA, 02138, US

(73) Assignee: Food Industry Research & Development Institute, Hsinchu (TW)

(21) Appl. No.: 11/760,306

(22) Filed: Jun. 8, 2007

Related U.S. Application Data
(63) Continuation of application No. 10/634,170, filed on Aug. 5, 2003.

(30) Foreign Application Priority Data
Dec. 4, 2002 (TW) 91135206

(51) Int. Cl. A23L 1/168

(52) U.S. Cl. 426/615

(57) ABSTRACT

A reconstituted grain product and manufacture method thereof. The reconstituted grain product includes a ground material having a plurality of raw whole grain. The method for manufacturing a reconstituted grain product includes providing a plurality of raw materials having whole grains, grinding the raw materials to afford a ground material with between 80˜200 meshes, and subjecting the ground material to mixing, extrusion with water addition, forming and drying to yield a reconstituted grain product.

### CROSS-REFERENCE TO RELATED APPLICATIONS

This application is a continuation-in-part of pending U.S. patent application Ser. No. 10/634,170, filed Aug. 5, 2003 and entitled “Reconstituted Grain Product,” which in turn claims priority to Taiwanese Patent Application 91135206, filed Dec. 4, 2002. The contents of the two prior applications are thereby incorporated by reference.

### BACKGROUND OF THE INVENTION

From ancient times to the present, cereal grains have been a primary food source for human beings. Recently, scientific studies on the functions or properties of cereal grains and legumes strengthen their importance for human health. Since different cereal grains and legumes have various physical and chemical properties, their water-absorption can be diverse. Overnight pre-cooking soaking in water may be necessary for some cereal grains and legumes. In addition, cooking requirements for different cereal grains and legumes are distinct, and the quality, such as softness and palatability, of the cooked mixture of cereal grains and legumes are inconsistent. Therefore, it is often inconvenient or less than enjoyable eat cooked mixtures of cereal grains and legumes.

U.S. Pat. No. 4,769,251 proposed by Wenger discloses a low shear process for the production of quick cooking rice products. In this process, a mixture containing 60˜80% by weight of rice material selected from rice flour and rice granules and mixtures thereof and 20˜40% by weight of water are prepared in a preconditioner. The mixture retained in the preconditioner is then partially cooked by elevating the temperature of the mixture to 65.5° C.˜98.8° C. for 20 seconds to 3 minutes. After that, the partially cooked mixture is introduced into a barrel of an extruder. The extruder has a cooking zone, a venting zone, a forming zone, and an extrusion die. The partially cooked mixture is sequentially passed through the cooked zone, the venting zone, the forming zone, and the extrusion die to yield an extruded product. The partially cooked mixture is retained at 82.2° C.˜148.8° C. for 10 to 25 seconds in the cooking zone. After vacuum treatment in the venting zone, the mixture is retained at 54.4° C.˜121° C. for 20 to 60 seconds and subjected to pressures of 200˜1200 psig in the forming zone. Finally, the extruded product is drier at 23.8° C.˜121° C. for 10 to 60 minutes to yield quick cooking rice products. The quick cooking rice products are edible after immersing in boiling water or hot water for 5 to 10 minutes.

The above mentioned process for the quick cooking rice products is complicated, including multiple steps. In addition, special equipment such as a vacuum is required, presenting inconvenience for general processing. Moreover, the ingredients of the quick cooking rice products merely include rice flour and rice granules, limiting the nutritional and functional value. There is, therefore, still a need to improve the process and the product.

### SUMMARY OF THE INVENTION

The invention provides a method for manufacturing a reconstituted grain product comprising providing a plurality of raw materials including whole grains, wherein the whole grains contain brans and germs, grinding the raw materials to afford a ground material having a size of 80˜200 meshes, and subjecting the ground material to mixing, extrusion with added water to provide a extruded material, forming and drying to yield the reconstituted grain product, wherein the extrusion is carried out to yield non-puffed and reconstituted grain product.

The invention further provides a reconstituted grain product manufactured by the above-mentioned method, wherein the reconstituted grain product is a non-puffed food.

### DETAILED DESCRIPTION OF THE INVENTION

It is therefore a primary object of the invention to provide a not-ready-to-eat reconstituted grain product that is easy to cook and has consistent softness, springiness, and moistness after cooking.

One aspect of the invention relates to a method for manufacturing a reconstituted grain product. The method includes providing a plurality of raw materials having whole grains that contain brans and germs, grinding the raw materials to form a ground material to 80˜200 meshes, and subjecting the ground material to mixing, extrusion with water addition, forming and drying to yield a reconstituted grain product, wherein the extrusion is carried out at a condition to yield non-puffed and reconstituted grain product.

The raw materials may further contain a plurality of legumes. The ground material has a size of 80˜200 meshes, or 100˜200 meshes. The comparison of grain with different particle sizes for twin-screw extrusion operation is listed in table 1.

TABLE 1

| | Grain particle size | |
|---|---|---|
| The manufacturing | Smaller than | 80-200 |
| item and quality | 80 meshes | meshes |
| Grinding of whole | Easy | Difficult |
| grain material | | |
| Homogeneous mixing | Difficult | Easy |
| Feeding control of | Difficult | Easy |
| material | | |
| Extrusion and | Cannot be | Completely cooked, |
| cooking | completely cooked, | homogeneously |
| | contain granular | gelatinized |
| | structure | |
| Forming | Yes | Yes |
| Appearance | Coarse (brans of | Meticulous (surface |
| | grains will be | is smooth) |
| | peeling off) | |
| Cooking in water | Reconstituted grain | Reconstituted grain |
| | product is broken | product is complete |
| | down and dissolved | and in good shape |
| Mouth feel | Coarse | Meticulous and |
| | | resilient |

In one embodiment, the grains include whole grains, but are not limited to, rice, barley, oat, buckwheat, adlay, millet, sorghum, corn, rye, wheat, and rice bran or wheat germ. Among these, rice is about 10˜90% by weight of the ground material, e.g., about 25% by weight. Barley, oat, buckwheat, adlay, millet, sorghum, corn, wheat, or rye is 1˜50% by weight of the ground material respectively. If desired, barley can be about 17.5% by weight of the ground material, oats can be about 17.5% by weight, buckwheat can be 17.5% by weight, adlay can be 17.5% by weight. Rice bran is 1˜10% by weight of the ground material, e.g., about 5% by weight, wheat germ is 1-10% by weight of the ground material, e.g., about 5% by weight. The legumes include, but are not limited to, soy bean, black bean, mung bean, small red bean, and sword bean.

Another aspect of the invention relates to a reconstituted grain product, which includes a plurality of raw grains, wherein the raw grains have various respective cooking requirements. Furthermore, the reconstituted grain product further comprises a plurality of legumes, and the raw grains and legumes both contain brans and germs.

Additionally, the reconstituted grain product of the invention is a kind of non-puffed food and cannot be puffed by any means. It may have a bulk density of 0.73 to 0.82 g/ml and a compact structure.

As the mentioned above, the reconstituted grain product of the invention is a non-puffed product, which has a dense and hard structure. Additionally, bulk density is weight of the product per unit volume, and high bulk density means dense and hard structure. Thus, the reconstituted grain cannot be eaten if no cooking.

In another embodiment, the reconstituted grain product of the invention further contains one or more additives. The additives can be a nutrient-enhancing agent, e.g., calcium or iron-enhancing agents, or a texture modifier such as emulsifier or phosphate, or a thickening agent such as modified starch, CMC, guargum, alginate or pectin.

The “various cooking requirements” for these grains and legumes include, but are not limited to, high-pressure cooking, steaming and cooking in water.

In still another aspect of the invention, the method for manufacturing a reconstituted grain product includes providing a plurality of raw materials comprising grains, grinding the raw materials to form a ground material with between 80˜200 meshes, and subjecting the ground material to mixing, extrusion at 50-150° C. for 1-3 minutes, forming an drying to yield a reconstituted grain product in the form of a rice kernel shape, wherein the grains and legumes include brans and germs. Additionally, the plurality of raw materials further includes legumes.

The ground material of the reconstituted grain product in the invention may have a size between 100˜200 meshes.

In one embodiment, the grains include whole grains, but are not limited to, rice, barley, oats, buckwheat, adlay, millet, sorghum, corn, rye, wheat, and rice bran or wheat germ. Among these, rice is about 10˜90% by weight of the ground material, e.g., about 25% by weight. Barley, oat, buckwheat, adlay, millet, sorghum, corn, wheat, or rye is 1˜50% by weight of the ground material respectively. If desired, barley can be about 17.5% by weight of the ground material, oats can be about 17.5% by weight, buckwheat can be 17.5% by weight, adlay can be 17.5% by weight. Rice bran is 1˜10% by weight of the ground material, e.g., about 5% by weight, wheat germ can be 1-10% by weight of the ground material, e.g. about 5% by weight. The legumes include, but are not limited to, soy bean, black, bean, mung bean, small red bean and sword bean.

The step “extrusion and forming” can be accomplished by methods commonly used in the art. Alternatively, tableting process may be applied.

The step “extrusion” can be performed by using an twin-screw extruder at screw rotation rate of 30 to 250 rpm, and barrel temperature is 50˜150° C. for 1˜3 minutes, or at 50˜110° C. for 1˜3 minutes. The total water content of the ground material is 20˜50% by weight, or 29˜39% by weight, in the extrusion step. The temperature of the outlet is about 70 to 95° C., and the back pressure is about 10˜100 kg/cm².

The step “forming” comprises passing the ground material through a 4-12 pore rice kernel-shape die exit and shaping the product by a cutting machine with 2-8 knives. The rotation speed of the cutting machine is about 400˜3000 rpm, e.g., 500˜1500 rpm.

The step “drying” can be performed at 45˜50° C. for 3˜4 hours, and final moisture content of the product is about 10˜14%.

The reconstituted grain product, which is not a ready-to-eat product, and mixed with rice at 1:1, and an equal volume of water can be added into the mixture. Cooking conditions are the same as those of rice, and an electric rice cooker can be used.

Short time soaking of the reconstituted grain product before cooking is optional. In addition, the softness, springiness, and moistness of the cooked reconstituted grain product are similar to cooked rice irrespective of the nature of constituent grains and legumes.

The reconstituted grain product in the invention has several advantages. First, the reconstituted grain product is easy to cook since hours of long-time soaking before cooking is unnecessary. The cooking condition and process are the same as household rice cooking. Cooking can be accomplished for the reconstituted grain product with or without short time (5-15 minutes) pre-soaking. Second, the reconstituted grain product solves the problems of different cooking requirements for various grains and legumes. Third, the softness, springiness, and moistness of the cooked reconstituted grain product are similar to cooked rice. Fourth, the dietary fiber content of the reconstituted grain product exceeds 6% by weight, and its bulk density is similar to polisled rice and shows as a non-puffed product (shown as table 2). An additive or dietary supplement can also be added to enhance or balance nutritional value of the product.

TABLE 2

| | Calorie | Dietary | Bulk density |
|---|---|---|---|
| Sample | (Kcal/100 g) | fiber (g) | (g/ml) |
| Reconstituted | 367 | 6.04 | 0.82 |
| grain product | | | |
| Polished rice | 355 | 0.40 | 0.92 |

Whole grain product, without any addition of dietary fiber.

Without intending to limit it in any manner, the invention will be further illustrated by the following examples.

### EXAMPLE

### Preparation of the Reconstituted Grain Product

### Example 1

25% by weight of non-glutinous long-grain indica rice, 17.5% by weight of barley, 17.5% by weight of oat, 17.5% by weight of buckwheat, 17.5% by weight of adlay, and 5% by weight of rice bran were evenly mixed and fed in a barrel of a JSW twin-screw extrusion machine (The Japan Steel Work Ltd., Hiroshima, Japan). The rotation rate of the feeding machine was 30 rpm for the material loading, and 20 rpm for water loading, and with 3˜5 sets of kneading elements in addition to 16-18 sets of forwarding elements on the extruding screw. The barrel was retained at 50˜110° C. when the rotation rate of the screw was 80 rpm, and the mixture exited an 8-pore rice kernel-shape die. The temperature of the outlet was about 70 to 95° C. Shaping was performed by a 6-knife cutting machine at a rotation rate of 1450 rpm. The product was dried at 45˜50° C. for 3˜4 hours. The final moisture content of the product was 10 to 14%. The product was cooled and packaged. The physical properties of the sample were listed in table 3.

TABLE 3

| | Width | Length | Hardness |
|---|---|---|---|
| Sample | (mm) | (mm) | (g) |
| 1 | 2.43 | 4.29 | 2.2 × 10³ |

### Example 2

75% by weight of non-glutinous short-grain japonica rice, 10% by weight of barley, 10% by weight of adlay, and 5% by weight of soybean protein isolate (SPI) were evenly mixed and fed in a barrel of a JSW twin-screw extrusion machine. The rotation rate of the feeding machine was 30 rpm for the material loading, and 20 rpm for water loading, with 3˜5 sets of kneading elements. The barrel was retained at 70˜100° C. when the rotation rate of the screw was 80 rpm, and the mixture exited an 8-pore rice kernel-shape die. The temperature of the outlet was about 70 to 95° C. Shaping was performed by a 6-knife cutting machine at a rotation rate of 1450 rpm. The product was dried at 45˜50° C. for 3˜4 hours. The final moisture content of the product was 10 to 14%. The product was cooled and packaged. The physical properties of these samples were listed in Table 4.

TABLE 4

| | Barrel temper- | Width | Length | Hardness |
|---|---|---|---|---|
| Sample | ature (° C.) | (mm) | (mm) | (g) |
| 2 | 70 | 3.03 | 4.34 | 7.8 × 10³ |
| 3 | 80 | 2.86 | 4.63 | 10.2 × 10³ |
| 4 | 90 | 2.98 | 4.51 | 7.7 × 10³ |
| 5 | 100 | 3.03 | 4.69 | 8.6 × 10³ |

### Example 3

30% by weight of non-glutinous long-grain indica rice, 15% by weight of barley, 25% by weight of oat, 25% by weight of corn, and 5% by weight of wheat germ were evenly mixed and fed in a barrel of a ZENIX twin-screw extrusion machine (ZENIX IND. CO. LTD., Taiwan). The material feeding rate was 80 kg/hr, and 20 kg/hr for water loading, with 3˜5 sets of kneading elements. The barrel was retained at 80˜120° C. when the rotation rate of the screw was 80 rpm, and the mixture exited an 12-pore rice kernel-shape die. The temperature of the outlet was about 70 to 95° C. Shaping was performed by a 6-knife cutting machine at a rotation rate of 1000 rpm. The product was dried at 45˜50° C. for 3˜4 hours. The final moisture content of the product was 10 to 14%. The product was cooled and packaged. The physical properties of the sample were listed in table 5.

TABLE 5

| | Width | Length | Dietary | Bulk density |
|---|---|---|---|---|
| Sample | (mm) | (mm) | fiber (g) | (g/ml) |
| 6 | 2.51 | 4.64 | 6.04 | 0.82 |

While the invention has been particularly shown and described with the reference to the preferred embodiments thereof, it will be understood by those skilled in the art that various changes in form and details may be made without departing from the spirit and scope of the invention.

What is claimed is:

1. A method for manufacturing a reconstituted grain product comprising:
providing a plurality of raw materials including whole grains, wherein the whole grains contain brans and germs,
grinding the raw materials to afford a ground material having a size of 80˜200 meshes, and
subjecting the ground material to mixing, extrusion with added water to provide a extruded material, forming and drying to yield the reconstituted grain product, wherein the extrusion is carried out to yield non-puffed and reconstituted grain product.

2. The method of claim 1, wherein the raw materials further includes legumes.

3. The method of claim 2, wherein the legumes include at least one of soy bean, black bean, mung bean, small red bean, and sword bean.

4. The method of claim 1, wherein the ground material is between 100-200 meshes.

5. The method of claim 1, wherein the whole grains include at least one of rice, barley, oat, buckwheat, adlay, millet, sorghum, corn, rye, wheat, wheat germ, and rice bran.

6. The method of claim 5, wherein the whole grains include barley, oats, or adlay of 1-50% by weight, respectively.

7. The method of claim 5, wherein the whole grains includes the rice of about 10-90% by weight.

8. The method of claim 5, wherein the whole grains include rice bran and wheat germ of 1-10% by weight, respectively.

9. The method of claim 1, wherein the extrusion is carried out by an extrusion machine having a outlet, and the outlet has a temperature of 70 to 95° C.

10. The method of claim 1, wherein the extrusion is carried out at 50-150° C.

11. The method of claim 1, wherein the extrusion provides a heating time between 1-3 minutes.

12. The method of claim 1, wherein the extruded material has a total water content between 20%-50%.

13. The method of claim 1, wherein the reconstituted grain product has a bulk density of 0.73-0.82 g/ml.

14. A reconstituted grain product manufactured by the method of claim 1, wherein the reconstituted grain product is a non-puffed food.

15. The reconstituted grain product of claim 14, wherein the reconstituted grain product has a bulk density of 0.73-0.82 g/ml.

16. The reconstituted grain product of claim 14, wherein the dietary fiber content of the reconstituted grain product exceeds 6% by weight.
